(19) United States
(12) Patent Application Publication
(10) Pub. No.: US 2019/0202740 A1
(43) Pub. Date: Jul. 4, 2019

(54) METHOD OF MAKING A CERAMIC COMPOSITE MATERIAL BY COLD SINTERING

(71) Applicant: SABIC Global Technologies B.V., Bergen op Zoom (NL)

(72) Inventors: Michael Laurin, Pittsfield, MA (US); Devendra Bajaj, Evansville, IN (US); Jonathan Bock, Albuquerque, NM (US); Kris Verlinde, Bergen op Zoom (NL)

(21) Appl. No.: 16/327,644

(22) PCT Filed: Aug. 25, 2017
(86) PCT No.: PCT/US2017/048715

§ 371 Date: Feb. 22, 2019

Related U.S. Application Data
(60) Provisional application No. 62/379,858, filed on Aug. 26, 2016.

(51) Int. Cl. C04B 35/01; C04B 35/453; C04B 35/634; C04B 35/638; C04B 35/645; B29C 39/00; B32B 18/00

(52) U.S. Cl. CPC C04B 35/016; C04B 35/453; C04B 35/63448; C04B 35/638; C04B 35/645; B29C 39/003; B29K 2079/085; C04B 2235/3268; C04B 2235/3284; C04B 2235/6021; C04B 2235/606; C04B 2235/656; B32B 18/00

(57) ABSTRACT

Ceramic composite materials, devices and methods are shown. In selected examples, ceramic materials are processed at low temperatures that permit incorporation of low temperature components, such as polymer components. manufacturing methods include, but are not limited to, injection molding, autoclaving and calendaring.

### CLAIM OF PRIORITY

This application claims the benefit of priority to U.S. Provisional Patent Application Ser. No. 62/379,858, filed on Aug. 26, 2016, which is hereby incorporated by reference herein in its entirety.

### TECHNICAL FIELD

This invention relates to ceramic composite materials, applications and products made using ceramic composite materials, and methods/manufacturing devices involving ceramic composite materials. In one example, this invention relates to ceramic composite materials that include at least one polymer integrated within a sintered microstructure.

### BACKGROUND

Sintering ceramic materials typically involves using a polymer binder to hold a ceramic powder together in a green state. The ceramic powder and polymer binder are heated to very high temperatures where the polymer binder is burned off leaving only the ceramic material behind. At the high temperatures, the grains of the ceramic powder begin to fuse together at contact points to form a sintered microstructure of ceramic material only.

Sintered ceramic composite materials are desirable due to potential combinations of material properties from both matrix and dispersed phases. However, as with the burn off of polymer binder in green state manufacture, the high temperature processing of ceramic powders in sintering makes many ceramic composite materials impossible. It is desired to be able to form sintered ceramic structures at lower temperatures that permit various composite combinations, such as ceramic and polymer composite materials.

### BRIEF DESCRIPTION OF THE DRAWINGS

FIG. 1A shows a mixture of powder particles prior to heating according to an example of the invention.

FIG. 1B shows the material of FIG. 1A after some amount of heating according to an example of the invention.

FIG. 2A shows a tool in one step of a manufacturing process according to an example of the invention.

FIG. 2B shows the tool from FIG. 2A and workpiece materials in another step of a manufacturing process according to an example of the invention.

FIG. 2C shows the tool from FIG. 2A and workpiece materials in another step of a manufacturing process according to an example of the invention.

FIG. 2D shows a composite ceramic object formed according to an example of the invention.

FIG. 3 shows a portion of a manufacturing process according to an example of the invention.

FIG. 4 shows a portion of a manufacturing process according to an example of the invention.

FIG. 5 shows a method of forming a sintered ceramic component according to an example of the invention.

FIG. 6 shows a method of forming a sintered ceramic component according to an example of the invention.

FIG. 7 shows a method of forming a sintered ceramic component according to an example of the invention.

FIG. 8 shows a method of forming a sintered ceramic component according to an example of the invention.

FIGS. 9A and 9B show diametral compression test setup and transverse strain map according to an example of the invention.

FIG. 10 shows micrographs of samples according to an example of the invention.

FIG. 11 shows additional micrographs of samples according to an example of the invention.

FIG. 12 shows a die configuration according to an example of the invention.

FIG. 13 shows additional micrographs of samples according to an example of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

As used herein, the term “injection molding” refers to a process for producing a molded part or form by injecting a composition including one or more polymers that are thermoplastic, thermosetting, or a combination thereof, into a mold cavity, where the composition cools and hardens to the configuration of the cavity. Injection molding can include the use of heating via sources such as steam, induction, cartridge heater, or laser treatment to heat the mold prior to injection, and the use of cooling sources such as water to cool the mold after injection, allowing faster mold cycling and higher quality molded parts or forms. An insert for an injection mold can form any suitable surface within the mold, such as a surface that contacts at least part of the injection molded material, such as a portion of an outer wall of the mold, or such as at least part of an inner portion of the mold around which the injection molded material is molded. An insert for an injection mold can be an insert that is designed to be separated from the injection molded material at the conclusion of the injection molding process. An insert for an injection mold can be an insert that is designed to be part of the injection molded product (e.g., a heterogeneous injection molded product that includes the insert bonded to the injection molded material), wherein the injection molded product includes a junction between the injection molded material and the insert.

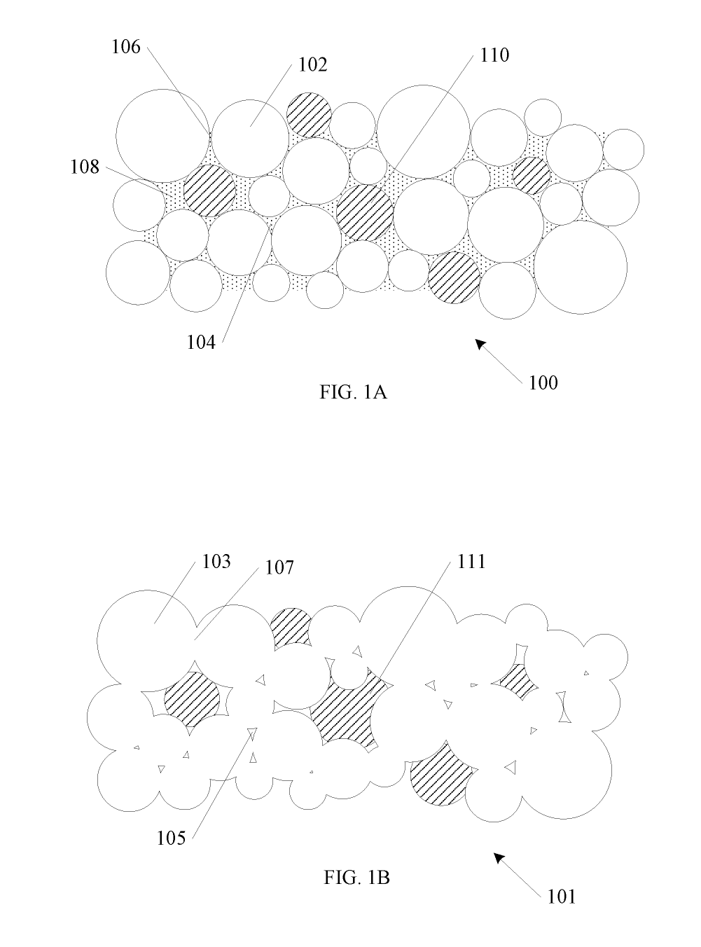

FIG. 1A shows a mixture 100 of powder particles prior to heating according to an example of the invention. The mixture 100 includes a number of ceramic particles 102 that touch each other at contact points 106. A number of voids 104 are shown between the number of ceramic particles 102, as a result of interference between particles 102 at the contact points 106. A number of secondary particles 110 are also shown as part of the mixture 100. After sintering, the number of secondary particles 110 will remain within the microstructure of the final material and become a dispersed phase within a sintered ceramic matrix phase to form a sintered ceramic composite material.

While round powder granules are used in the illustration of FIGS. 1A and 1B as an example, the invention is not so limited. Other shapes of particles for both ceramic particles 102 and secondary particles 110 may include whiskers, rods, fibrils, fibers, platelets, and other physical forms that provide contact points with each other as illustrated in FIG. 1A.

In one example the ceramic particles 102 include binary ceramics, such as molybdenum oxide (MoO₃). In other examples, the ceramic particles 102 may include binary, ternary, quaternary, etc. compounds consisting of oxides, fluorides, chlorides, iodides, carbonates, and phosphate families One example of a ternary ceramic particle includes K₂Mo₂O₇ Although these example ceramic families are used as examples, the list is not exhaustive. Any ceramic that is capable of cold sintering as described in the present disclosure is within the scope of the invention.

Selected examples of ceramic materials that are capable of cold sintering include, but are not limited to, BaTiO₃, Mo₂O₃, WO₃, V₂O₃, V₂O₅, ZnO, Bi₂O₃, CsBr, Li₂CO₃, CsSO₄, LiVO₃, Na₂Mo₂O₇, K₂Mo₂O₇, ZnMoO₄, Li₂MoO₄, Na₂WO₄, K₂WO₄, Gd₂(MoO₄)₃, Bi₂VO₄, AgVO₃, Na₂ZrO₃, LiFeP₂O₄, LiCoP₂O₄, KH₂PO₄, Ge(PO₄)₃, Al₂O₃, MgO, CaO, ZrO₂, ZnO—B₂O₃—SiO₂, PbO—B₂O₃—SiO₂, 3ZnO-2B₂O₃, SiO₂, 27B₂O₃-35Bi₂O₃-6SiO₂-32ZnO, Bi₂₄Si₂O₄₀, BiVO₄, Mg₃(VO₄)₂, Ba₂V₂O₇, Sr₂V₂O₇, Ca₂V₂O₇, Mg₂V₂O₇, Zn₂V₂O₇, Ba₃TiV₄O₁₅, Ba₃ZrV₄O₁₅, NaCa₂Mg₂V₃O₁₂, LiMg₄V₃O₁₂, Ca₅Zn₄(VO₄)₆, LiMgVO₄, LiZnVO₄, BaV₂O₆, Ba₃V₄O₁₃, Na₂BiMg₂V₃O₁₂, CaV₂O₆, Li₂WO₄, LiBiW₂O₈, Li₂Mn₂W₃O₁₂, Li₂Zn₂W₃O₁₂, PbO—WO₃, Bi₂O₃-4MoO₃, Bi₂Mo₃O₁₂, Bi₂O-2.2MoO₃, Bi₂Mo₂O₉, Bi₂MoO₆, 1.3Bi₂O₃—MoO₃, 3Bi₂O₃-2MoO₃, 7Bi₂O₃—MoO₃, Li₂Mo₄O₁₃, Li₃BiMo₃O₁₂, Li₈Bi₂Mo₇O₂₈, Li₂O—Bi₂O₃—MoO₃, Na₂MoO₄, Na₆MoO₁₁O₃₆, TiTe₃O₈, TiTeO₃, CaTe₂O₅, SeTe₂O₅, BaO—TeO₂, BaTeO₃, Ba₂TeO₅, BaTe₄O₉, Li₃AlB₂O₆, Bi₆B₁₀O₂₄, Bi₄B₂O₉. Although individual ceramic materials are listed, the disclosure is not so limited. In selected examples, the ceramic component can include combinations of more than one ceramic material, including, but not limited to, the ceramic materials listed above.

In one example, a ceramic material used in a cold sintering operation described in the present disclosure may possess some degree of piezoelectric behavior. In one example, a ceramic material used in a cold sintering operation described in the present disclosure may possess some degree of ferroelectric behavior. One example of such a material may include, but is not limited to, BaTiO₃, as included in the non-limiting list of examples above.

In one example, the secondary particles 110 include polymer particles. In one example of polymer particles, the polymer 110 may include a thermoplastic polymer, such as polypropylene. In one example of polymer particles, the polymer 110 may include a thermoset polymer, such as an epoxy or the like. In one example of polymer particles, the polymer 110 may include an amorphous polymer. In one example of polymer particles, the polymer 110 may include a crystalline polymer. In one example of polymer particles, the polymer 110 may include a semi-crystalline polymer. In one example of polymer particles, the polymer 110 may include a blend, such as a miscible or immiscible blend polymer. In one example of polymer particles, the polymer 110 may include a homopolymer. In one example of polymer particles, the polymer 110 may include a co-polymer, such as a random, or block co-polymer. In one example of polymer particles, the polymer 110 may include a branched polymer. In one example of polymer particles, the polymer 110 may include an ionic or non-ionic polymer.

Some specific examples of acceptable polymers include, but are not limited to, polyethylene, Polyester, acrylonitrile butadiene styrene (ABS), Polycarbonate (PC), Polypheneleneoxide (PPO), Polybutylterephthalate (PBT), isophthalate terphthalate (ITR), Nylon, HTN, polyphenyl sulfide (PPS), liquid crystal polymer (LCP), Polyaryletherketone (PAEK), polyether ether ketone (PEEK), Polyetherimide (PEI), Polyimide (PI), Fluoropolymers, PES, Polysulfone (PSU), PPSU, SRP (Paramax™), PAI (Torlon™), and blends thereof.

In one example, the mixture 100 may include one or more resins or oligomers that may be polymerized within a mold, such as an injection mold, or other tooling surface along with other components of the mixture 100. In one example, the resin is flowable. An example flowable resin can form any suitable proportion of the mixture 100 composition, such as about 50 wt % to about 100 wt %, about 60 wt % to about 95 wt %, or about 50 wt % or less, or less than, equal to, or greater than about 60 wt %, 62, 64, 66, 68, 70, 72, 74, 76, 78, 80, 82, 84, 86, 88, 90, 91, 92, 93, 94, 95, 96, 97, 98, 99, 99.9, 99.99, or about 99.999 wt % or more. One or more curable resins may be included within a flowable resin. The one or more curable resins in the flowable resin can be any one or more curable resins, such as an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN). The flowable resin composition can include polycarbonate (PC), acrylonitrile butadiene styrene (ABS), polybutylene terephthalate (PBT), polyethylene terephthalate (PET), polyetherimide (PEI), poly(p-phenylene oxide) (PPO), polyamide (PA), polyphenylene sulfide (PPS), polyethylene (PE) (e.g., ultra high molecular weight polyethylene (UHMWPE), ultra low molecular weight polyethylene (ULMWPE), high molecular weight polyethylene (HMWPE), high density polyethylene (HDPE), high density cross-linked polyethylene (HDXLPE), cross-linked polyethylene (PEX or XLPE), medium density polyethylene (MDPE), low density polyethylene (LDPE), linear low density polyethylene (LLDPE) and very low density polyethylene (VLDPE)), polypropylene (PP), or a combination thereof. The flowable resin can be polycarbonate, polyacrylamide, or a combination thereof.

In various embodiments, the flowable resin composition includes a filler. The flowable resin can include one filler or more than one filler. The one or more fillers can form about 0.001 wt % to about 50 wt % of the flowable resin composition, or about 0.01 wt % to about 30 wt %, or about 0.001 wt % or less, or about 0.01 wt %, 0.1, 1, 2, 3, 4, 5, 10, 15, 20, 25, 30, 35, 40, 45 wt %, or about 50 wt % or more. The filler can be homogeneously distributed in the flowable resin composition. The filler can be fibrous or particulate. The filler can be aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin including various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers; sulfides such as molybdenum sulfide, zinc sulfide, or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as fillers such as mica, clay, feldspar, flue dust, fillite, quartz, quartzite, perlite, Tripoli, diatomaceous earth, carbon black, or the like, or combinations including at least one of the foregoing fillers. The filler can be talc, kenaf fiber, or combinations thereof. The filler can be coated with a layer of metallic material to facilitate conductivity, or surface treated with silanes, siloxanes, or a combination of silanes and siloxanes to improved adhesion and dispersion with the flowable resin composition. The filler can be selected from carbon fibers, a mineral fillers, or combinations thereof. The filler can be selected from mica, talc, clay, wollastonite, zinc sulfide, zinc oxide, carbon fibers, glass fibers, ceramic-coated graphite, titanium dioxide, or combinations thereof.

In one example, the secondary particles 110 may include one or more metals. Examples of metals that may be used include, but are not limited to, lithium, beryllium, sodium, magnesium, aluminum, potassium, calcium, scandium, titanium, vanadium, chromium, manganese, iron, cobalt, nickel, copper, zinc, gallium, rubidium, strontium, yttrium, zirconium, niobium, molybdenum, technetium, ruthenium, rhodium, palladium, silver, cadmium, indium, tin, cesium, barium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, bismuth, polonium, francium, radium, actinium, thorium, protactinium, uranium, neptunium, plutonium, americium, curium, berkelium, californium, einsteinium, fermium, mendelevium, nobelium, lawrencium, rutherfordium, dubnium, seaborgium, bohrium, hassium, meitnerium, darmstadtium, roentgenium, copernicium, ununtrium, flerovium, ununpentium, and livermorium.

In one example the mixture 100 includes more than one type of secondary particle 110. For example, the secondary particles 110 may include both metal particles and polymer particles. In another example, the secondary particles 110 may include both polymer particles and carbon particles, such as carbon black, graphite, carbon nanotubes, graphene, fullerenes, etc. In another example, the secondary particles 110 may include both polymer particles and modifying or reinforcing particles such as glass fibers, or other fibers.

FIG. 1A further shows an activation solvent 108 that is present, at least partially within the microstructure of the mixture 100. In one example, the activation solvent 108 includes water. Various forms of water and/or water application that may be introduced include liquid water, atomized or sprayed water, water vapor, etc. In one example, the activation solvent 108 includes an alcohol. Other examples include a mixture of different liquids or gasses to form the activation solvent 108. One of ordinary skill in the art, having the benefit of the present disclosure, will recognize that a choice of activation solvent 108 will depend on the choice of ceramic particles 102 and a choice of secondary particles 110. An effective activation solvent 108 will be capable of activating low temperature diffusion and/or material transport at the contact points 10 between ceramic particles 102. The effective activation solvent 108 will also not adversely affect material properties of the secondary particles 110. For example, an effective activation solvent 108 will not react with the secondary particles 110 in such a way as to make the secondary particles 110 volatile below a sintering or activation temperature of the ceramic particles 102.

FIG. 1B shows a composite material 101 formed after processing the mixture 100 from FIG. 1A. The microstructure shown in FIG. 1B illustrates a sintered or partially sintered microstructure. Material at contact points 106 shown in FIG. 1A have migrated to form joined regions 107 that connect sintered regions 103 that were formerly separate ceramic particles 102 prior to sintering. In one example, the activation solvent 108 provides a mechanism to move material from the ceramic particles 102 to the joined regions 107 at lower temperatures than would be possible without the activation solvent 108. In one example, the activation solvent 108 reduces a temperature required for sintering low enough that secondary particles 110 including polymer will not vaporize during sintering, and will remain within a final microstructure, as shown in FIG. 1B. Other materials apart from polymers that require a low sintering temperature may also remain as a result of low temperature sintering.

After sintering, the microstructure of FIG. 1B is a composite material 101 that includes sintered regions 103 and joined regions 107 as a substantially continuous matrix phase. At least some of the secondary particles 110 remain behind and form a dispersed phase 111 within remaining pores 105 of the composite material 101. As noted above, as a result of low temperature sintering, at least a portion of the secondary particles 110, such as polymer particles, are not vaporized, and remain within the microstructure.

In the example shown in FIG. 1B, the ceramic matrix phase includes a degree of closed cell porosity. In other words, after sintering, a number of remaining pores 105 are completely surrounded by ceramic matrix phase, and are no longer accessible from outside the microstructure. Any remaining secondary particles 110, such as polymer particles, can only be present within closed cell pores because they were located within the mixture 100 during sintering, and remained present as a result of a sintering temperature below vaporization. It is not possible to introduce a dispersed phase material to an interior of a closed cell pore after sintering.

In one example, polymer secondary particles 110 are raised to a temperature during sintering that exceeds a glass transition temperature (T_{g}) of the polymer but does not exceed a volatilization temperature of the polymer. In one example, polymer secondary particles 110 are raised to a temperature during sintering that exceeds a melting temperature (Tₘ) of the polymer but does not exceed a volatilization temperature of the polymer. In addition to an ability to not exceed a volatilization temperature, in selected examples, the polymer secondary particles 110 are raised to a temperature during sintering that does not exceed a breakdown temperature, where a desired molecular weight may be reduced.

It may be desirable for the polymer secondary particles 110 to flow within the remaining pores 105 and to fill the space during sintering. a larger contact area between the dispersed phase 111 and the surrounding ceramic matrix may be provided in such a configuration. Advantages of increased contact area may include improved mechanical properties, such as increased toughness, improved fracture strength, improved fracture strain, and/or more desirable failure modes, such as an object cracking but not falling apart. In one example exceeding a glass transition temperature (T_{g}) or a melting temperature (Tₘ) of the chosen polymer may provide these features.

One of ordinary skill in the art, having the benefit of the present disclosure, will recognize that a sufficient activation temperature and pressure will depend on a number of factors, such as the choice of ceramic material and the choice of activating solvent. One non-limiting examples includes use of water as an activating solvent, and a temperature in excess of 100° C. to activate the system.

FIG. 1B illustrates at least some degree of closed cell porosity, and a dispersed phase 111, such as a polymer dispersed phase, within at least some of the closed cells of the sintered microstructure. Because the dispersed phase 111 results primarily from the original secondary particles 110, materials of the dispersed phase 111 are substantially similar or identical to the materials of the secondary particles 110 as described above.

In other examples, closed cell porosity may not be present, however, a cold sintered microstructure will be physically observable, and distinguishable over traditional high temperature sintering. In one example, X-ray diffraction can be used to detect crystal structure in the sintered regions 103. High temperature sintering may lead to crystal structure changes in the microstructure of sintered regions 103. These crystalline changes will not be present in a cold sintered microstructure.

In another example, elemental analysis can be used to detect a presence or absence of compounds such as hydroxides and carbonates. In a high temperature sintering process, these compounds will be burned off, and not be found in the microstructure. In cold sintered structures, because temperatures during sintering will not have reached a high enough point to burn off such compounds, compounds such as hydroxides and carbonates will still be present, and detectable, indicating that the sintered microstructure was formed using cold sintering techniques.

In another example an amount of densification can be measured. In a high temperature sintering process, the ceramic components may become more fully dense that in a cold sintering process. Additionally, grain growth in a cold sintered microstructure may be lower than in a high temperature sintering process, with proportionally more growth at contact points in cold sintering than in the individual grains themselves.

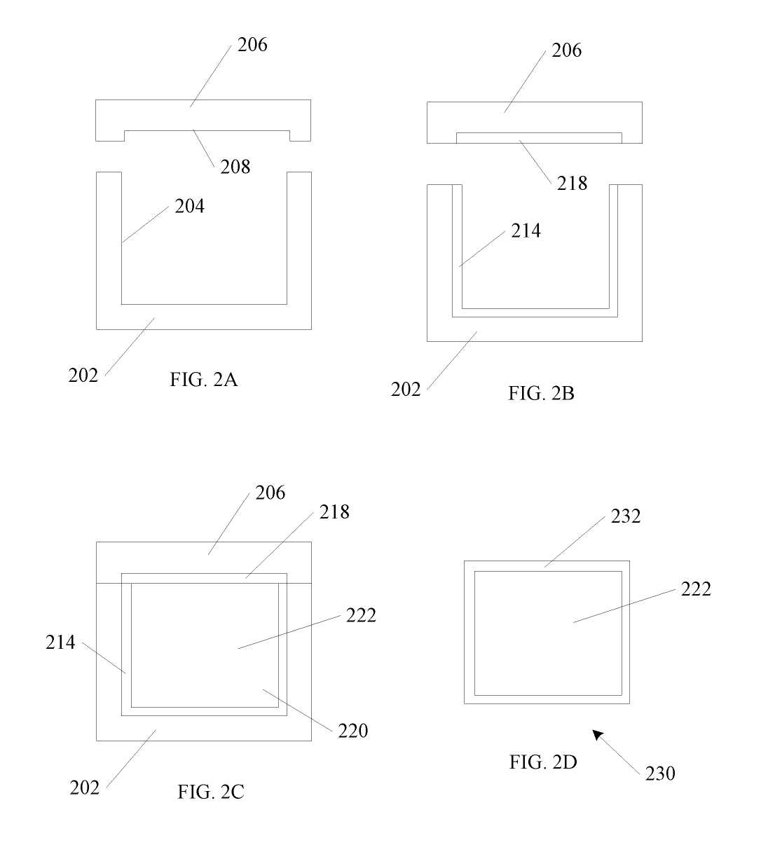

FIGS. 2A-2D show one example of a manufacturing method and resulting product formed using ceramic composite materials as described above. In FIG. 2A, a first tool 202 and a mating tool 206 are shown. In one example the first tool 202 and the mating tool 206 are portions of a mold. The first tool 202 includes a first tool surface 204, and the mating tool 206 includes a mating tool surface 208. In one example, one or more tool surfaces (204, 208) are electrostatically charged.

In FIG. 2B, an amount of powder, including a cold sinterable ceramic powder as described in examples above, is electrostatically charged opposite to the charge on the one or more tool surfaces (204, 208). When an amount of the powder is introduced to the one or more tool surfaces (204, 208), a coating is formed as a result of electrostatic attraction between the opposite charges. Coating 214 is shown over the first tool surface 204, and coating 218 is shown over the mating tool surface 208.

As noted in examples above, the amount of a powder may only include cold sinterable ceramic powder. In other examples, the amount of a powder may include secondary particles such as polymer, carbon, metals, etc. as described in examples above. In one example the charge on the amount of the powder is retained in polymer secondary particles as described in examples above. Selected ceramic particles may not be capable of retaining sufficient charge on their own, and the addition of polymer secondary particles may facilitate the coating process. In one example other secondary particles in addition to polymer particles may facilitate the coating process. In one example carbon particles such as graphite, carbon black, graphene, fullerenes, etc. may provide an improved ability to retain charge and as a result facilitate the coating process.

In one example, after the one or more tool surfaces (204, 208) have been coated, an amount of an activating solvent is applied. As described above, in one example the activating solvent includes water. Various forms of water and/or water application that may be introduced include liquid water, atomized or sprayed water, water vapor, etc. In one example, the activation solvent includes an alcohol. Other examples include a mixture of different liquids or gasses to form the activation solvent.

In FIG. 2C, the first tool 202 and the mating tool 206 are closed together to form an interior space 220 that is completely enclosed by the coating 214 and coating 218. In one example, the interior space 220 is then filled with a polymer core 222. Sufficient heat and pressure are then to the coatings (214, 218) and activating solvent to activate sintering of the powder in the coatings (214, 218).

Because the sintering process uses an activating solvent as described above, sintering may be accomplished at temperatures lower than a vaporization temperature of the polymer core 222. As a result, FIG. 2D shows a composite material object 230 that includes a substantially solid sintered ceramic shell formed from now sintered and continuous coatings (214, 218), and a polymer core 222 within the sintered ceramic shell. The composite material object 230 is not possible without use of low temperature sintering processes as described above. In other high temperature sintering procedures, the polymer core 222 would become volatile during sintering, and not be retained within the interior space 220 after sintering.

One of ordinary skill in the art, having the benefit of the present disclosure, will recognize that a sufficient activation temperature and pressure will depend on a number of factors, such as the choice of ceramic material and the choice of activating solvent. One non-limiting example includes use of water as an activating solvent, and a temperature in excess of 100° C. to activate the system. A non-limiting example of pressure in injection molding may range from 0.5 tons to 7000 tons of clamping pressure. A non-limiting example of pressure in compression molding may range from 10,000 psi to 87,000 psi of clamping pressure.

In one example, polymer resin, monomer, oligomer, or similar precursor polymer molecules may be introduced to an amount of cold sinterable ceramic powder and subjected to heat and/or pressure within an injection mold tool, such as the tool shown in block diagram form in FIGS. 2A-2C. In one example, the precursor polymer molecules may be polymerized and/or cured at the same time that the cold sinterable ceramic powder is sintered. In one example, an amount of partially cured polymer may be injected into the injection mold, for example using a screw ram. In one example, the use of partially cured polymer better facilitates use of a screw ram. The partially cured polymer may have sufficient mechanical structure in its partially cured state, for this process, in contrast to a liquid monomer that may be difficult to place into an injection mold using a screw ram.

In one example a first temperature and pressure may be used to activate the cold sintering process, while a second temperature and pressure may be used to activate polymerization and/or curing of the polymer precursor molecules. In other examples, a single temperature and pressure may be used to activate polymerization and/or curing of the polymer precursor molecules and to activate the cold sintering process at the same time.

In one example, applying pressure may include compressing the flowable resin composition in the mold to any suitable pressure, such as about 1 MPa to about 5,000 MPa, about 20 MPa to about 80 MPa, or such as about 0.1 MPa or less, or less than, equal to, or greater than 0.5 MPa, 1, 2, 3, 4, 5, 10, 15, 20, 25, 30, 35, 40, 45, 50, 55, 60, 65, 70, 75, 80, 90, 100, 125, 150, 175, 200, 250, 300, 400, 500, 750, 1,000, 1,500, 2,000, 2,000, 3,000, 4,000, or about 5,000 MPa or more. The method can include holding the mold cavity in the compressed state (with the flowable resin composition and the cold sinterable ceramic powder) for a predetermined time period, such as about 0.1 s to about 10 h, about 1 s to about 5 h, or about 5 s to about 1 min, or about 0.1 s or less, or about 0.5 s, 1, 2, 3, 4, 5, 10, 20, 30, 45 s, 1 min, 2, 3, 4, 5, 10, 15, 20, 30, 45 min, 1 h, 2, 3, 4, or about 5 h or more.

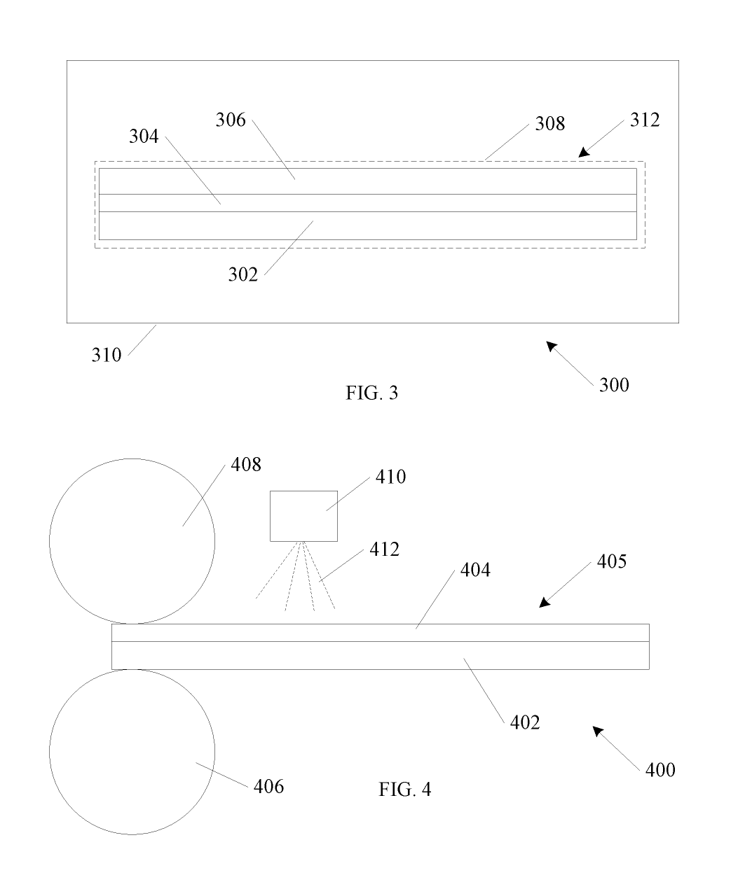

FIG. 3 shows another example of a manufacturing method and resulting product formed using ceramic composite materials as described above. A manufacturing system 300 is shown. In FIG. 3, an amount of a powder 304, including a cold sinterable ceramic powder is placed in contact with a first tool surface 302. As noted in examples above, the amount of a powder 304 may only include cold sinterable ceramic powder. In other examples, the amount of a powder 304 may include secondary particles such as polymer, carbon, metals, etc. as described in examples above.

An amount of an activating solvent is applied to the amount of powder 304. As described above, in one example the activating solvent includes water. Various forms of water and/or water application that may be introduced include liquid water, atomized or sprayed water, water vapor, etc. In one example, the activation solvent 108 includes an alcohol. Other examples include a mixture of different liquids or gasses to form the activation solvent.

In one example, a mating tool surface 306 is placed over the first tool surface 302 with the powder 304 between the first tool surface 302 and the mating tool surface 306. In one example, the first tool surface 302, the mating tool surface 306, and the powder 304 are places in a vacuum bag 308 to form an assembly 312. In one example, the assembly 312 is then placed in an autoclave 310 and sufficient heat and pressure is applied to the powder and solvent to activate sintering of the powder 304.

In the example of FIG. 3, the vacuum bag 308 facilitates application of pressure, while the autoclave provides heat to activate the system. Although vacuum bagging is used as an example for pressure application, other methods and tools may be used, such as mechanical pressure between dies, etc. Although an autoclave is used as an example of a method to apply heat, the invention is not so limited. Other heat sources may be used without departing from the scope of the invention.

One advantage of using vacuum bagging techniques includes the ability to apply uniform pressure to tooling and/or powder compacts having complex shapes. Although two flat plates are shown in FIG. 3 as an example curved plates, non-planar configurations, and complex shapes may be formed using vacuum bagging.

One of ordinary skill in the art, having the benefit of the present disclosure, will recognize that a sufficient activation temperature and pressure will depend on a number of factors, such as the choice of ceramic material and the choice of activating solvent. One non-limiting examples includes use of water as an activating solvent, and a temperature in excess of 100° C. to activate the system. A non-limiting example of pressure in autoclaving may range up to 0.137 MPa. A non-limiting example of time duration in autoclaving may rand from about 20 to about 360 minutes.

FIG. 4 shows another example of a manufacturing method and resulting product formed using ceramic composite materials as described above. A manufacturing system 400 is shown. In FIG. 4, an amount of a powder 404, including a cold sinterable ceramic powder is placed in contact with a first tool surface 402. As noted in examples above, the amount of a powder 404 may only include cold sinterable ceramic powder. In other examples, the amount of a powder 404 may include secondary particles such as polymer, carbon, metals, etc. as described in examples above.

FIG. 4 shows the first tool surface 402 and the amount of a powder 404 together forming a stack 405. An amount of an activating solvent 412 is applied to the amount of powder 404. A block diagram of a dispenser 410 is shown, however any number of application devices may be used to introduce the activating solvent 412. As described above, in one example the activating solvent includes water. Various forms of water and/or water application that may be introduced include liquid water, atomized or sprayed water, water vapor, etc. In one example, the activation solvent 108 includes an alcohol. Other examples include a mixture of different liquids or gasses to form the activation solvent.

FIG. 4 further shows running the stack through one or more calendaring rolls. In the example of FIG. 4, a first calendaring roll 406 and a second calendaring roll 408 are shown. For ease of illustration, the stack 405 is shown as substantially flat, and only two calendaring rolls (406, 408) are shown. Other configurations may include running a flexible stack 405 around at least a partial arc of a calendaring roll and the use of additional calendaring rolls as needed.

In one example, sufficient heat and pressure are applied to the stack 405 to activate sintering of the powder 404. Heated calendaring rolls may be used. In one example, the rolls (for example 406, 408) are pressed together to provide the necessary pressure to activate sintering of the powder 404.

One of ordinary skill in the art, having the benefit of the present disclosure, will recognize that a sufficient activation temperature and pressure will depend on a number of factors, such as the choice of ceramic material and the choice of activating solvent. One non-limiting examples includes use of water as an activating solvent, and a temperature in excess of 100° C. to activate the system. A non-limiting example of pressure in calendaring may range from about 100 to about 1000 pounds per linear inch.

In one example, application of the amount of a powder 404 to the first tool surface 402 may be accomplished using electrostatic methods as described with respect to FIGS. 2A-2D above. As described above, in selected examples it may be advantageous to use additions of secondary particles to the powder 404 to improve charge retention in an electrostatic example. In one example polymer particles may facilitate the coating process by holding a charge. In one example carbon particles such as graphite, carbon black, graphene, fullerenes, etc. may provide an improved ability to retain charge and as a result facilitate the coating process.

In one example, a coefficient of thermal expansion (CTE) of a composite material as described in the present disclosure may be modified by selecting respective amounts of a cold sintered ceramic component and a polymer second phase component. Modification of a CTE in a composite material may facilitate matching of a CTE with an adjacent component to prevent stress fractures or other failures that may be induced by a CTE mismatch in adjacent components.

Selected example composite dielectric materials were tested to determine their CTEs. In one example, the CTE for cold-sintered hybrid materials was measured using a TA instruments thermal mechanical analyzer TMA Q400 and the data was analyzed using Universal Analysis V4.5A from TA instruments.

Samples were re-shaped to form 13 mm round diameter, 2 mm thickness pellets to fit the TMA Q400 equipment. The sample, once placed in the TMA Q400, was heated to 150° C. (@20° C./min) at which point the moisture and stress was relieved and then cooled to −80° C. (@20° C./min) to start the actual coefficient of thermal expansion measurement. The sample was heated from −80° C. to 150° C. at 5° C. per minute at which the displacement is measured over temperature.

The measurement data was then loaded into the analysis software and the coefficient of thermal expansion was calculated using the Alpha x1-x2 method. The method measured the dimension change from temperature T1 to temperature T2 and transforms the dimension change to a coefficient of thermal expansion value with the following equation:

$$CTE ( µm \text{/} ( m {*}^{ °} C . ) ) = \frac{Δ L}{Δ T * L 0}$$

Where:

ΔL=change in length (μm)

ΔT=change in temperature (° C.)

L0=sample length (m)

The coefficient of thermal expansion of three polymers, including polyether imide (PEI), polystyrene (PS) and polyester, each in LiMn₂O₄ (LMO) cold sintered samples, in varying levels, were tested with the TMA Q400. The results can be found in Table 1 below.

TABLE 1
coefficient of thermal expansion of LMO/PEI, LMO/PS
and LMO/polyester cold sintered composites

| | CTE (μm/(m*K)) | | |
|---|---|---|---|
| | −40° C. | 23° C. | −40° C. |
| Sample | to 40° C. | to 80° C. | to 125° C. |
| Neat LMO | 11.6 | 13.1 | 13 |
| LMO/20 vol % PEI | 14.5 | 16.9 | 15.3 |
| LMO/40 vol % PEI | 19.9 | 22.4 | 22.1 |
| LMO/60 vol % PEI | 28.4 | 31.5 | 30.7 |
| LMO/80 vol % PEI | 38.1 | 43.1 | 41.1 |
| 100% PEI (datasheet | 54 | 54 | 54 |
| value −20° C. to 150° C.) | | | |
| LMO/5 wt % (13.8 vol %) | 12 | 14.3 | NA |
| Polystyrene powder | | | |
| LMO/10 wt % (22.3 vol %) | 15.9 | 17.6 | 16.9 |
| Polyester powder | | | |

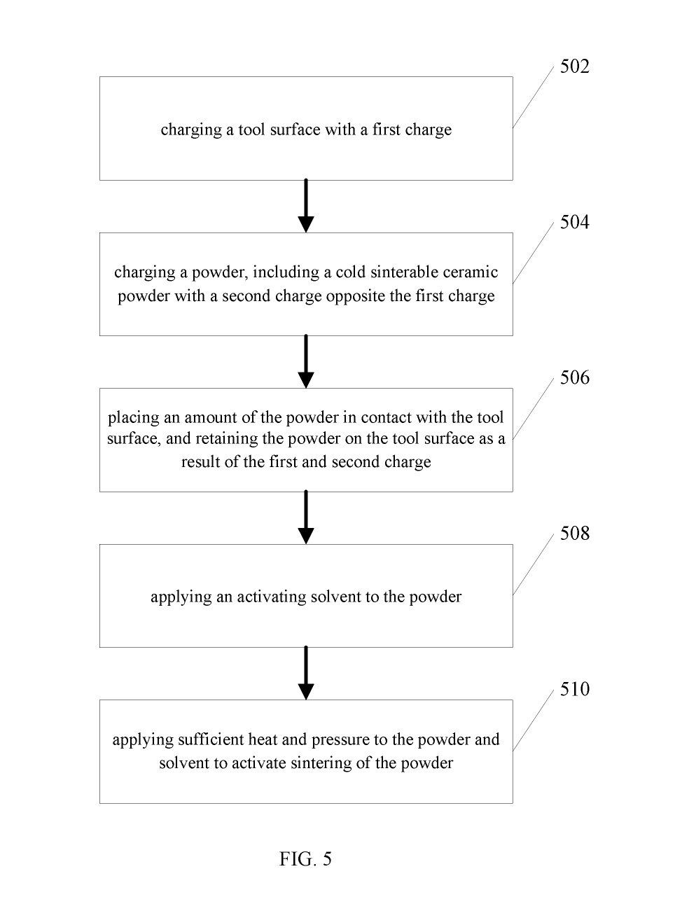

FIG. 5 shows an example of a flow diagram of one method of manufacture according to an embodiment of the invention. In operation 502, a tool surface is charged with a first charge. In operation 504, a powder, including a cold sinterable ceramic powder is charged with a second charge opposite the first charge. In operation 506, an amount of the powder is placed in contact with the tool surface, and the powder is retained on the tool surface as a result of the first and second charge. In operation 508, an activating solvent is applied to the powder. Lastly, in operation 510, sufficient heat and pressure is applied to the powder and solvent to activate sintering of the powder.

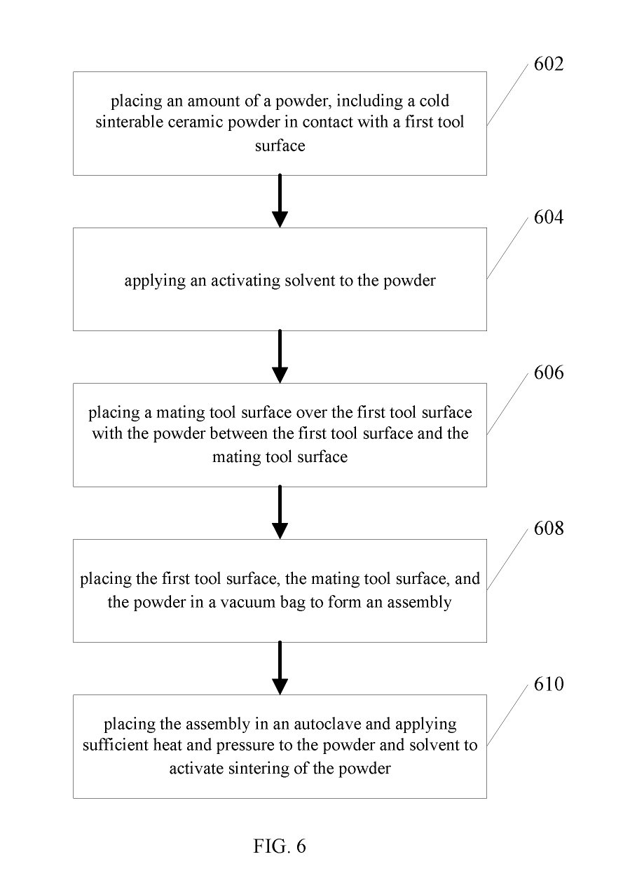

FIG. 6 shows another example of a flow diagram of one method of manufacture according to an embodiment of the invention. In operation 602, an amount of a powder, including a cold sinterable ceramic powder is placed in contact with a first tool surface. In operation 604, an activating solvent is applied to the powder. In operation 606, a mating tool surface is placed over the first tool surface with the powder between the first tool surface and the mating tool surface. In operation 608, the first tool surface, the mating tool surface, and the powder are placed in a vacuum bag to form an assembly. Lastly, in operation 610, the assembly is placed in an autoclave and sufficient heat and pressure is applied to the powder and solvent to activate sintering of the powder.

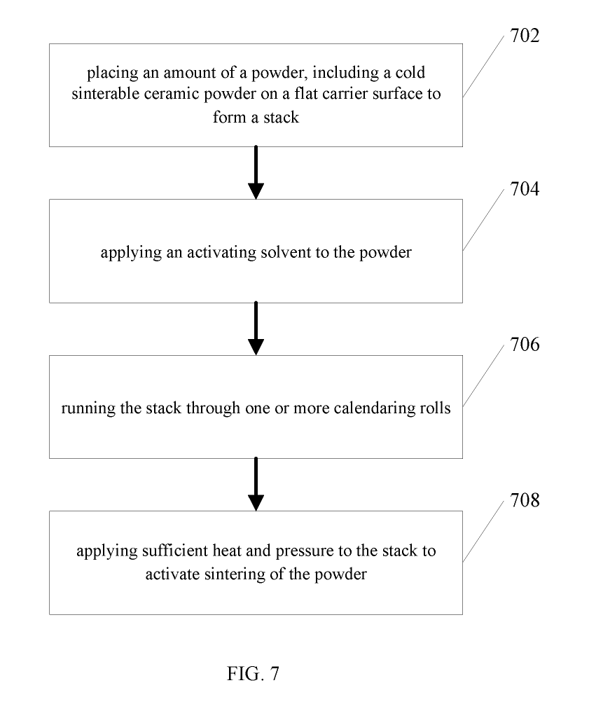

FIG. 7 shows another example of a flow diagram of one method of manufacture according to an embodiment of the invention. In operation 702, an amount of a powder, including a cold sinterable ceramic powder is placed on a flat carrier surface to form a stack. In operation 704, an activating solvent is applied to the powder. In operation 706, the stack is run through one or more calendaring rolls. In operation 708, sufficient heat and pressure is applied to the stack to activate sintering of the powder.

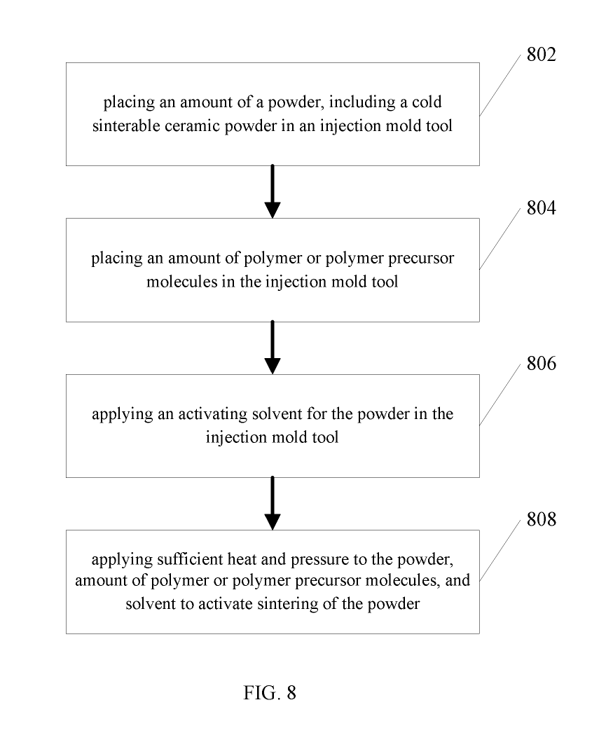

FIG. 8 shows another example of a flow diagram of one method of manufacture according to an embodiment of the invention. In operation 802, an amount of a powder, including a cold sinterable ceramic powder is placed in an injection mold tool. In operation 804, an amount of polymer or polymer precursor molecules are placed in the injection mold tool. In operation 806, an activating solvent for the powder is applied in the injection mold tool. In operation 808, sufficient heat and pressure is applied to the powder, amount of polymer or polymer precursor molecules, and solvent to activate sintering of the powder.

In selected examples, any cold sinterable ceramic powder as described in the present disclosure may be dried prior to processing. Although a solvent, such as water may be used in selected examples to facilitate cold sintering, the added process of drying the cold sinterable ceramic powder prior to applying solvent and pressure may improve mechanical properties including, but not limited to, fracture stress, fracture strain, fracture toughness, etc.

In selected examples, any cold sinterable ceramic powder as described in the present disclosure may be annealed after cold sintering. In selected examples, an annealing process may include holding a cold sintered ceramic composite as described in the present disclosure at a temperature at or above a glass transition temperature (T_{g}) of the polymer component for a given amount of time after cold sintering. In selected examples, an annealing process may include holding a cold sintered ceramic composite as described in the present disclosure at a temperature at or above a melting temperature (Tₘ) of the polymer component for a given amount of time after cold sintering. A glass transition temperature may apply generally to an amorphous polymer or amorphous component of a polymer. A melting temperature may apply generally to a crystalline or semicrystalline polymer or a crystalline or semicrystalline component of a polymer.

In selected examples, annealing changes a microstructure of the cold sintered ceramic composite to increase an interfacial surface area between polymer and ceramic. In selected examples, annealing changes a microstructure of the cold sintered ceramic composite to connect regions of polymer into a more cohesive polymer phase within the cold sintered ceramic composite. For example, an annealed polymer may flow either by exceeding a glass transition temperature, or by partially or fully melting. Some degree of flow in the polymer phase may positively affect mechanical properties of the cold sintered ceramic composite.

To demonstrate selected processing techniques and resulting properties, a number of non limiting examples are shown and described below. In the present disclosure, unless otherwise specified, LMO refers to Li₂MoO₄. Although LMO is used as an example, the invention is not so limited any ceramic capable of some degree of sintering as disclosed above is within the scope of the invention.

Diametral Compression Test

In the diametral compression test method, a circular disk is compressed along its diameter by two flat metal plates. The compression along the diameter creates a maximum tensile stress perpendicular to the loading direction in the mid-plane of the specimen [see ref. J J Swab et al., Int J Fract (2011) 172: 187-192]. The fracture strength (σ_{f}) of the ceramic can be calculated by:

$${σ}_{f} = \frac{2 P}{π Dt}$$

Where P is the fracture load, D is the disk diameter and t is the disk thickness.

All tests were conducted on an ElectroPlus™ E3000 All-electric dynamic test instrument (Instron) with a 5000 N load cell at room temperature. The specimens were mounted between two flat metal plates and a small pre-load of 5 N was applied. Diametral compression tests were conducted under displacement control (0.5 mm/min), and time, compressive displacement and load data was captured at 250 Hz.

Prior to testing, all specimens were speckled using black spray paint. During diametral compression, sequential images of the speckled surface were captured with INSTRON video extensometer AVE (Fujinon 35 mm) at a frequency of 50 Hz. Posttest, all images were analyzed using the DIC replay software (Instron) to generate full-field strain maps. Transverse strain (εx) was analyzed in a 6 mm×3 mm region in the mid-plane of each specimen and transverse strain (εₓ) was calculated. The fracture strain (ε_{f}) was calculated at the maximum load.

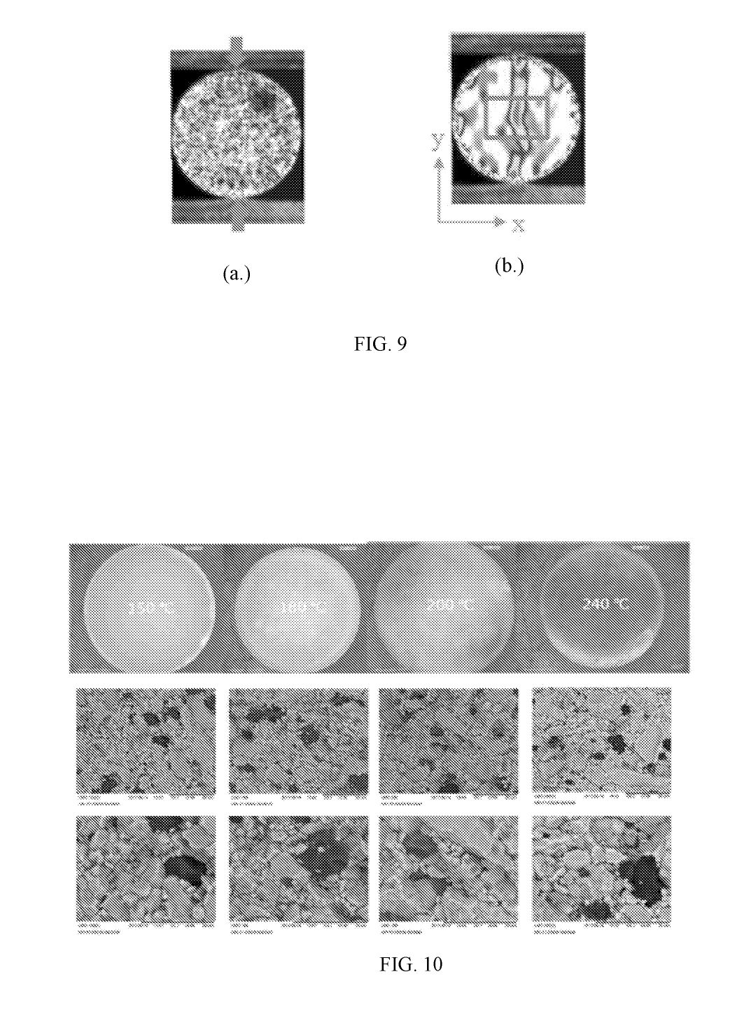

FIGS. 9A and 9B shows diametral compression test configuration. (9A) A specimen loaded under diametral compression. Arrows indicate the direction of applied load. The specimen surface is speckled with black paint. (9B) A full-field transverse strain (εₓ) map. The rectangular box in the mid-plane represents the region in which the transverse strain was calculated.

### Example A: Effects of Cold Sintering Temperature on Mechanical Properties of LMO/PEI Composite

LMO Sample

2 g of LMO powder was added to a mortar, wherein a 100 ul/g de-ionized water was added. The resultant mixture was then ground to a paste-like consistency using a pestle. The substance is added to the stainless steel die and pressed into a ceramic pellet at 268 MPa pressure and 150° C. temperature for 30 min.

LMO/PEI Composite Sample

2 g of PEI (ULTEM™ 1010; average particle size Dv50=15.4 μm; Molecular weight=51000 g/mol; Molecular number=21000; Tg=218° C.) filled LMO powder was added to a mortar, wherein a 100 ul/g de-ionized water was added. The resultant mixture was then ground to a paste-like consistency using a pestle. The substance is added to the stainless steel die and pressed into a ceramic pellet at 268 MPa pressure and 150° C. temperature for 30 min. The same process was repeated and one pellet each was also made at 180, 200 and 240° C. temperature. The microstructure of ceramic polymer composite at 150, 180, 200 and 240° C. is shown in FIG. 10. The mechanical properties obtained from diametral compression test are shown in Table 1. The molecular weight and molecular number of the polymer obtained from GPC analysis are listed in Table 2.

FIG. 10 shows an optical and SEM microscopy of LMO/PEI composite at 150, 180, 200 and 240° C.

TABLE 1
Summary of fracture stress and fracture strain for LMO/PEI
composite sintered at different temperatures.

| | | | | Number | | | | |
|---|---|---|---|---|---|---|---|---|
| LMO | PEI | PEI | Temperature | of | σ_{f} | % Change | | % Change |
| vol % | vol % | wt % | ° C. | pellets | (MPa) | vs LMO | ε_{f}[%] | vs LMO |
| 100 | 0 | 0 | 150 | 1 | 5.40 | 0 | 0.042 | 0 |
| 90 | 10 | 4.4 | 150 | 1 | 6.24 | +15.5 | 0.084 | +100 |
| 90 | 10 | 4.4 | 180 | 1 | 5.81 | +7.6 | 0.118 | +161 |
| 90 | 10 | 4.4 | 200 | 1 | 4.88 | −9.6 | 0.026 | −36 |
| 90 | 10 | 4.4 | 240 | 1 | 6.81 | +26 | 0.086 | +105 |

TABLE 2
Summary of molecular weight for LMO/PEI composite measured
via GPC.

| | | | | Number | | |
|---|---|---|---|---|---|---|
| | PEI | PEI | Temperature | of | Mₙ | M_{w} |
| LMO vol % | vol % | wt % | ° C. | pellets | (g/mol) | (g/mol) |
| 90 | 10 | 4.4 | 150 | 1 | 13237 | 45702 |
| 90 | 10 | 4.4 | 180 | 1 | 17569 | 47084 |
| 90 | 10 | 4.4 | 200 | 1 | 8320 | 32911 |
| 90 | 10 | 4.4 | 220 | 1 | 4997 | 22972 |
| 90 | 10 | 4.4 | 240 | 1 | 2894 | 7006 |

### Example B: Effect of Heat Treating at Temperature Higher than the Tg of the Polymer on the Molecular Weight and Microstructure of LMO/PEI Composite

LMO/PEI Composite Sample

2 g of PEI (ULTEM™ 1010; average particle size Dv50=1 μm) filled LMO powder was added to a mortar, wherein a 100 ul/g de-ionized water was added. The resultant mixture was then ground to a paste-like consistency using a pestle. The substance is added to the stainless steel die and pressed into a ceramic pellet at 268 MPa pressure and 120° C. temperature for 30 min. Two pellets were made each with 10 vol % ULTEM™ 1010 and 90 vol % LMO. One pellet was placed in an oven at 240° C. for 1 hour. Both pellets where analyzed by molecular weight. GPC results of heat treated and non-heat treated (control) are listed in Table 3. Results showed that unlike cold sintering at 240° C., which resulted in significant drop (>85%) in molecular weight of ULTEM™ 1010, heat treating in an oven at 240° C. resulted in a less <5% change in molecular weight.

TABLE 3
Summary of molecular weight for LMO/PEI composite
measured via GPC.

| | | | | Heat | | |
|---|---|---|---|---|---|---|
| | PEI | PEI | Temperature | treated at | Mₙ | M_{w} |
| LMO vol % | vol % | Wt % | ° C. | (° C.) | (g/mol) | (g/mol) |
| 90 | 10 | 4.4 | 120 | — | 20158 | 50424 |
| 90 | 10 | 4.4 | 120 | 240 | 19199 | 47958 |

LMO/PEI Composite Sample

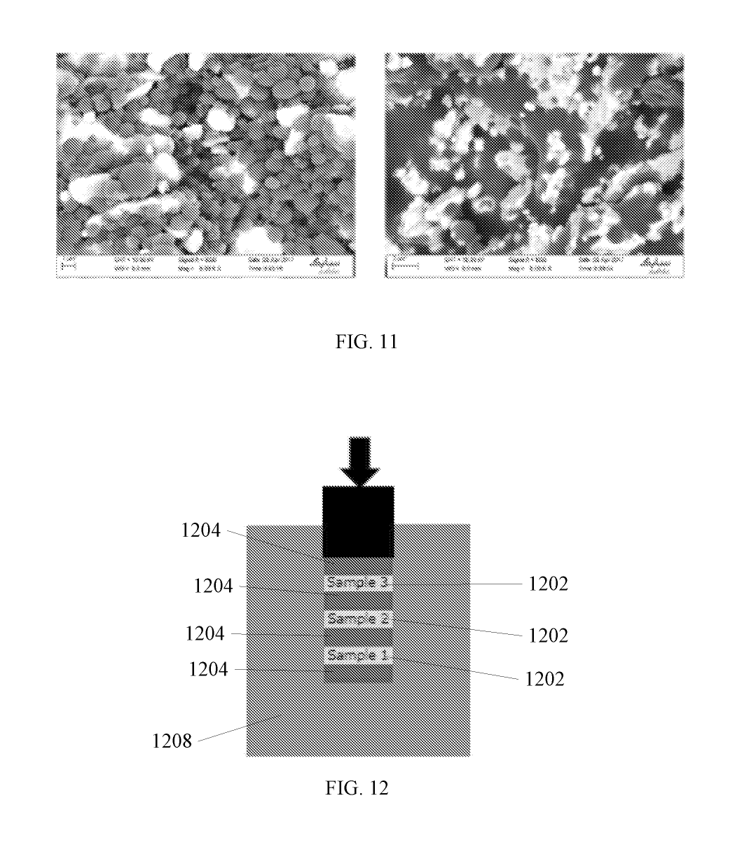

2 g of PEI (ULTEM™ 1010; average particle size Dv50=1 μm) filled LMO powder was added to a mortar, wherein a 100 ul/g de-ionized water was added. The resultant mixture was then ground to a paste-like consistency using a pestle. The substance is added to the stainless steel die and pressed into a ceramic pellet at 268 MPa pressure and 120° C. temperature for 30 min. One pellet was made with 40 vol % (21.7 wt %) ULTEM™ 1010 and 60 vol % LMO. The sample was broken in liquid Nitrogen and one half was heat treated in an oven for 1 hr at 260° C. Post-annealing the fractured surface both halves were imaged under a SEM and compared. The resulting images are showed in FIG. 11, demonstrating a clear change in morphology of the polymer particles form spherical morphology at 120° C. to melt-like morphology at 260° C.

FIG. 11 shows (Left) LMO/PEI composite made via cold sintering at 120° C. (Right) one-half of the sample annealed at 260° C. Composite is 60% vol of LMO and 40% vol ULTEM™ 1010.

### Example C: Effects of Drying on the Mechanical Properties of LMO and LMO/PEI Composite

LMO Sample

2 g of LMO powder was added to a mortar, wherein a 100 ul/g de-ionized water was added. The resultant mixture was then ground to a paste-like consistency using a pestle. The substance is added to the stainless steel die and pressed into a ceramic pellet at 268 MPa pressure and 150° C. temperature for 30 min. One pellet was tested as is and the other was dried overnight at 125° C. to remove moisture and then tested under diametral compression.

LMO/PEI Composite Sample

2 g of PEI (ULTEM™ 1010; average particle size Dv50=15.4 μm; Molecular weight=51000 g/mol; Molecular number=21000; Tg=218° C.) filled LMO powder was added to a mortar, wherein a 100 ul/g de-ionized water was added. The resultant mixture was then ground to a paste-like consistency using a pestle. The substance is added to the stainless steel die and pressed into a ceramic pellet at 268 MPa pressure and 240° C. temperature for 30 min. One pellet was tested as is and the other was dried overnight at 125° C. to remove moisture. The diametral compression test results are shown in Table 4.

TABLE 4
Summary of fracture stress and fracture strain for pure
LMO and LMO/PEI composite before and after drying at 125° C.

| | | | | | | % Change | | % Change |
|---|---|---|---|---|---|---|---|---|
| LMO | PEI | PEI | Temperature | Dried at | σ_{f} | vs No | | vs No |
| vol % | vol % | wt % | ° C. | 125° C. | (MPa) | Dry | ε_{f}(%) | Dry |
| 100 | 0 | 0 | 150 | No | 5.40 | 0 | 0.042 | 0 |
| 100 | 0 | 0 | 150 | Yes | 9.69 | +79 | 0.078 | +86 |
| 80 | 20 | 9.5 | 240 | No | 6.82 | — | 0.054 | — |
| 80 | 20 | 9.5 | 240 | Yes | 9.98 | +46 | 0.074 | +37 |

### Example D: Effects of Sintering Pressure on the Mechanical Properties of LMO/PEI Composite Sample

2 g of PEI (ULTEM™ 1010; average particle size Dv50=15.4 μm; Molecular weight=51000 g/mol; Molecular number=21000; Tg=218° C.) filled LMO powder was added to a mortar, wherein a 100 ul/g de-ionized water was added. The resultant mixture was then ground to a paste-like consistency using a pestle. The substance is added to the stainless steel die and pressed into a ceramic pellet at 134 MPa, 268 MPa or 402 MPa pressure and 240° C. temperature for 30 min. 4 pellets were made at 134 MPa pressure, 2 pellets were made at 268 MPa and 3 pellets were made at 402 MPa pressure. All pellets were dried overnight at 125° C. in an oven. The diametral compression test results are shown in Table 5. It was demonstrated that the LMO/PEI composite cold sintered at 268 MPa pressure exhibited the highest average fracture stress and fracture strain compared to the samples made at 134 and 402 MPa pressure.

TABLE 5
Summary of average fracture stress and average fracture strain
for LMO/PEI composite cold sintered at 134 MPa, 268 MPa, 402 MPa.

| | | | | | Number | | |
|---|---|---|---|---|---|---|---|
| LMO | PEI | PEI | Temperature | Pressure | of | σ_{f} | |
| vol % | vol % | Wt % | ° C. | (MPa) | pellets | (MPa) | ε_{f}(%) |
| 90 | 10 | 4.4 | 240 | 134 | 4 | 5.20 | 0.049 |
| 90 | 10 | 4.4 | 240 | 268 | 2 | 7.97 | 0.069 |
| 90 | 10 | 4.4 | 240 | 402 | 3 | 4.33 | 0.022 |

### Example E: Example 5: Effects of Change in Polymer Vol % on the Mechanical Properties of LMO/PEI Composite

LMO Sample

2 g of LMO powder was added to a mortar, wherein a 100 ul/g de-ionized water was added. The resultant mixture was then ground to a paste-like consistency using a pestle. The substance is added to the stainless steel die and pressed into a ceramic pellet at 268 MPa pressure and 150° C. temperature for 30 min. The LMO pellet was dried overnight at 125° C. in an oven and tested under diametral compression.

LMO/PEI Composite Sample

2 g of PEI (ULTEM™ 1010; average particle size Dv50=15.4 μm; Molecular weight=51000 g/mol; Molecular number=21000; Tg=218° C.) filled LMO powder was added to a mortar, wherein a 100 ul/g de-ionized water was added. The resultant mixture was then ground to a paste-like consistency using a pestle. The substance is added to the stainless steel die and pressed into a ceramic pellet at 268 MPa pressure and 240° C. temperature for 30 min. Pellets were dried overnight at 125° C. in an oven. The diametral compression test results are shown in Table 6 and FIG. 16.

TABLE 6
Summary of mechanical properties for LMO/PEI
composite at 20 and 40 vol % of PEI.

| LMO | PEI | PEI | Temperature | Dried at | σ_{f} | % Change | | % Change |
|---|---|---|---|---|---|---|---|---|
| vol % | vol % | Wt % | ° C. | 125° C. | (MPa) | vs LMO | ε_{f}[%] | vs LMO |
| 100 | 0 | 0 | 150 | Yes | 9.69 | 0 | 0.078 | 0 |
| 80 | 20 | 9.5 | 240 | Yes | 9.98 | +3 | 0.074 | −5 |
| 60 | 40 | 21.7 | 240 | Yes | 15.31 | +58 | 0.240 | +208 |

### Example F: Effects of Polymer Particle Size on the Mechanical Properties of LMO/PEI Composite

LMO Sample

2 g of LMO powder was added to a mortar, wherein a 100 ul/g de-ionized water was added. The resultant mixture was then ground to a paste-like consistency using a pestle. The substance is added to the stainless steel die and pressed into a ceramic pellet at 268 MPa pressure and 150° C. temperature for 30 min. The LMO pellet was dried overnight at 125° C. in an oven and tested under diametral compression.

LMO/PEI Composite Sample

2 g of PEI (ULTEM™ 1010) filled LMO powder was added to a mortar, wherein a 100 ul/g de-ionized water was added. PEI with 2 different average particle sizes were used. Large PEI is defined as spherical particles with volume average particle diameter Dv50=15.4 μm and number average diameter Dn50=1.8 μm. Small PEI is defined as spherical particles with volume average particle diameter Dv50=1.4 μm and number average particle diameter Dn50=18.7 nm. The resultant mixture was then ground to a paste-like consistency using a pestle. The substance is added to the stainless steel die and pressed into a ceramic pellet at 268 MPa pressure and 180° C. temperature for 30 min. Pellets were dried overnight at 125° C. in an oven. The diametral compression test results are shown in Table 7.

TABLE 7
Summary of fracture stress and fracture strain for
LMO/PEI composite made using two different average particle size of PEI.

| | | | | PEI Particle | | % | | % |
|---|---|---|---|---|---|---|---|---|
| LMO | PEI | PEI | Temperature | size average | | Change | | Change |
| vol % | vol % | Wt % | ° C. | (Dv50, μm) | σ_{f}(MPa) | vs LMO | ε_{f}[%] | vs LMO |
| 100 | 0 | 0 | 150 | — | 9.69 | 0 | 0.078 | 0 |
| 80 | 20 | 9.5 | 180 | 15.4 | 11.86 | +22 | 0.104 | +33 |
| 80 | 20 | 9.5 | 180 | 1.4 | 17.18 | +77 | 0.159 | +104 |

### Example G. Multi-Specimen Cold Sintering

LMO Samples

6 g of LMO powder was added to a mortar, wherein a 100 ul/g de-ionized water was added. The resultant mixture was then ground to a paste-like consistency using a pestle. 2 g of the LMO de-ionized water mixture was added to a stainless steel die 1808 with a stainless steel die pellet 1804 above and below the mixture. Another 2 g of the LMO de-ionized water mixture was added to the stainless steel die 1808 and another stainless steel die pellet 1804 was inserted on the top. Finally, another 2 g of the LMO de-ionized water mixture was added to the stainless steel die and a stainless steel die pellet 1804 was inserted on the top, and entire stack was pressed at 268 MPa pressure and 180° C. temperature for 30 min (FIG. 18). Between each sample and the steel die pellet a 13 mm diameter and 125 micron thick film of polyimide (Dupont™ Kapton® HN) was inserted. The resulting density of each pellet is listed in Table 8 and compared to a single LMO pellet made at the same temperature.

FIG. 12 shows one example configuration as described above for preparing multiple cold sintering parts. A number of components 1802 are shown in block diagram form, separated by a number of die pellets 1804.

TABLE 8
Density comparison between single pellet
versus multiple cold sintered pellets.

| LMO | Temperature | Single or | Specimen | Density |
|---|---|---|---|---|
| vol % | ° C. | Multiple | # | (%) |
| 100 | 180 | Single | 1 | 99.6 |
| 100 | 180 | Multiple | 1 | 98.6 |
| 100 | 180 | Multiple | 2 | 97.9 |
| 100 | 180 | Multiple | 3 | 97.9 |

### Example H. Milled Vs Un-Milled Ceramic

As-received LMO has a d₅₀ of >100 μm while milled LMO has a much smaller d₅₀ (<30 μm). The milled variety requires much less pressure than the unmilled variety to achieve a high density (>95%). The pressure-dependence therefore seems to be a function of particle size.

Table 9 below shows relative density for Li₂MoO₄ as a function of applied pressure at 120° C. and 100 μl/g solvent including milled and unmilled ceramic.

TABLE 9

| Ceramic | | | Relative |
|---|---|---|---|
| (Unmilled or | Temperature | Pressure | Density |
| Milled) | (° C.) | (MPa) | (%) |
| Unmilled | 120 | 74 | 78.1 |
| Unmilled | 120 | 110 | 85.1 |
| Unmilled | 120 | 147 | 92.1 |
| Unmilled | 120 | 221 | 97 |
| Unmilled | 120 | 294 | 97.5 |
| Milled | 120 | 74 | 96.9 |
| Milled | 120 | 110 | 97.2 |

Effects of Pressure During Cooling

Keeping the pressure on during cooling resulted in a higher relative density versus keeping the pressure off during cooling in LMO-PEI composite. FIG. 14 shows data for 10 vol % and 40 vol % PEI in LMO sintered at 240° C. Table 11 shows the effect of cooling condition and solvent content on the relative density at 240° C. FIG. 15 shows SEM micrographs of the LMO/PEI composite from the testing in FIG. 14 and table 11.

TABLE 11

| | | Pressure | solvent | Relative |
|---|---|---|---|---|
| LMO | PEI | on while | content | Density |
| vol % | vol % | cooling | (ul/g) | (%) |
| 90 | 10 | No | 50 | 87.5 |
| 90 | 10 | Yes | 50 | 96.9 |
| 90 | 10 | No | 25 | 87.1 |
| 90 | 10 | No | 12.5 | 79.9 |
| 60 | 40 | No | 50 | 64.8 |
| 60 | 40 | Yes | 50 | 97.5 |
| 80 | 20 | No | 50 | 73.3 |
| 80 | 20 | No | 25 | 79 |
| 80 | 20 | No | 12.5 | 86 |

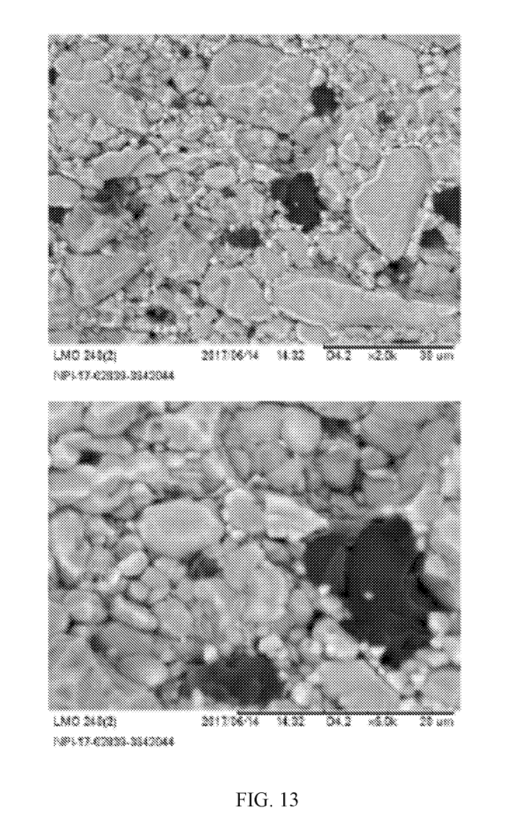

FIG. 13 illustrates a change in microstructure between a) cold sintered at 120° C. and b) cold sintered and annealed at 260° C. In one example, the anneal shown in FIG. 13 b) shows flow of the polymer as a result of the anneal, which may improve the mechanical properties of the composite material.

To better illustrate the method and apparatuses disclosed herein, a non-limiting list of embodiments is provided here:

Example 1 includes a method of forming a sintered ceramic composite component. The method includes placing an amount of powder, including a cold sinterable ceramic powder in a die, placing an amount of polymer or polymer precursor molecules in the die, applying an activating solvent for the powder in the die, heating to a first temperature, and applying sufficient pressure to the powder, amount of polymer or polymer precursor molecules, and solvent to activate sintering of the powder, and heating to a second temperature to anneal a polymer phase of the sintered ceramic composite component.

Example 2 includes the method of example 1, wherein the second temperature is equal to or greater than a glass transition temperature of an amorphous polymer phase.

Example 3 includes the method of any one of examples 1-2, wherein the second temperature is equal to or greater than a melting temperature of a semi-crystalline polymer phase.

Example 4 includes the method of any one of examples 1-3, further including holding the sintered ceramic composite component at pressure while cooling to room temperature.

Example 5 includes the method of any one of examples 1-4, wherein the polymer phase includes polyetherimide (PEI).

Example 6 includes the method of any one of examples 1-5, wherein the cold sinterable ceramic powder includes zinc oxide.

Example 7 includes the method of any one of examples 1-6, wherein applying sufficient pressure to the powder includes applying pressure less than or equal to 500 MPa.

Example 8 includes the method of any one of examples 1-7, wherein heating to the first temperature includes heating to a temperature no greater than 200° C. and above a boiling point of the activating solvent.

Example 9 includes the method of any one of examples 1-8, wherein heating to the second temperature includes heating to a temperature between about 220 and 260 degrees C.

Example 10 includes the method of any one of examples 1-9, wherein placing the amount of polymer or polymer precursor molecules in the die includes placing an amount of polymer or polymer precursor molecules to yield a 20%-50% by volume fraction of polymer in the sintered ceramic composite component.

Example 11 includes the method of any one of examples 1-10, further including drying the amount of powder before sintering.

Example 12 includes the method of any one of examples 1-11, further including drying the sintered ceramic composite component after sintering.

Example 13 includes the method of any one of examples 1-12, wherein placing the amount of powder, including a cold sinterable ceramic powder in a die includes placing powder with an average diameter smaller than 30 μm.

Example 14 includes the method of any one of examples 1-13, wherein multiple components are stacked within a single die and sufficient heat and pressure are applied to the multiple components concurrently.

Example 15 includes a composite material object. The composite material object includes a substantially solid sintered ceramic shell, and a polymer core within the sintered ceramic shell.

Example 16 includes the composite material object of example 15, wherein the substantially solid sintered ceramic shell has a sintered microstructure that includes a degree of closed cell porosity, and a dispersed phase polymer within at least some of the closed cells of the sintered microstructure.

Example 17 includes the composite material object of any one of examples 15-16, wherein the dispersed phase polymer includes polypropylene.

Example 18 includes the composite material object of any one of examples 15-17, wherein the polymer core is a thermoplastic polymer core.

Example 19 includes the composite material object of any one of examples 15-18, wherein the polymer core is a thermoset polymer core.

Example 20 includes the composite material object of any one of examples 15-19, wherein the polymer core is a semi-crystalline polymer core.

Example 21 includes the composite material object of any one of examples 15-20, wherein the polymer core is an amorphous polymer core.

Example 22 includes the composite material object of any one of examples 15-21, wherein the polymer includes polypropylene.

Example 23 includes a method of forming a sintered ceramic component. The method includes charging a tool surface with a first charge, charging a powder, including a cold sinterable ceramic powder with a second charge opposite the first charge, placing an amount of the powder in contact with the tool surface, and retaining the powder on the tool surface as a result of the first and second charge, applying an activating solvent to the powder, and applying sufficient heat and pressure to the powder and solvent to activate sintering of the powder.

Example 24 includes the method of example 23, wherein charging a powder includes charging a powder mixture of sinterable ceramic powder and polymer powder.

Example 25 includes the method any one of examples 23-24, wherein charging a powder includes charging a powder mixture of sinterable ceramic powder, polymer powder, and carbon powder.

Example 26 includes the method any one of examples 23-25, wherein applying an activating solvent to the powder includes applying an atomized activating solvent to the powder.

Example 27 includes the method any one of examples 23-26, wherein applying an activating solvent to the powder includes applying a gas phase activating solvent to the powder.

Example 28 includes the method any one of examples 23-27, wherein applying an activating solvent to the powder includes applying water to the powder.

Example 29 includes the method any one of examples 23-28, wherein applying water to the powder includes exposing the powder to higher than ambient humidity for an amount of time.

Example 30 includes the method any one of examples 23-29, wherein charging a tool surface includes charging an inner surface of an injection mold.

Example 31 includes the method any one of examples 23-30, further including injecting polymer into the injection mold to form a sintered ceramic shell with a polymer core.

Example 32 includes the method any one of examples 23-31, wherein applying sufficient heat and pressure includes autoclaving a vacuum bagged component.

Example 33 includes the method any one of examples 23-32, wherein applying sufficient heat and pressure includes calendaring a stack including a carrier surface and a layer of the powder.

Example 34 includes a method of forming a sintered ceramic component. The method includes placing an amount of a powder, including a cold sinterable ceramic powder in contact with a first tool surface, applying an activating solvent to the powder, placing a mating tool surface over the first tool surface with the powder between the first tool surface and the mating tool surface, placing the first tool surface, the mating tool surface, and the powder in a vacuum bag to form an assembly, and placing the assembly in an autoclave and applying sufficient heat and pressure to the powder and solvent to activate sintering of the powder.

Example 35 includes the method of example 34, wherein placing the amount of the powder in contact with a first tool surface includes placing on a flat tool surface.

Example 36 includes the method any one of examples 34-35, wherein placing the amount of the powder in contact with a first tool surface includes placing on a curved tool surface.

Example 37 includes the method any one of examples 34-36, wherein placing the amount of the powder in contact with a first tool surface includes placing a powder mixture of sinterable ceramic powder and polymer powder.

Example 38 includes a method of forming a sintered ceramic component. The method includes placing an amount of a powder, including a cold sinterable ceramic powder on a flat carrier surface to form a stack, applying an activating solvent to the powder, running the stack through one or more calendaring rolls, and applying sufficient heat and pressure to the stack to activate sintering of the powder.

Example 39 includes the method of example 38, wherein placing the amount of the powder on a flat carrier includes placing a powder mixture of sinterable ceramic powder and polymer powder.

Example 40 includes the method any one of examples 38-39, wherein placing the amount of the powder on a flat carrier includes charging the flat carrier surface with a first charge, and charging the powder with a second charge opposite the first charge.

Example 41 includes the method any one of examples 38-40, wherein charging the powder with a second charge opposite the first charge includes charging a powder mixture of sinterable ceramic powder and polymer powder.

Example 42 includes the method any one of examples 38-41, wherein charging the powder with a second charge opposite the first charge includes charging a powder mixture of sinterable ceramic powder, polymer powder, and carbon powder.

Example 43 includes a method of forming a sintered ceramic component. The method includes placing an amount of a powder, including a cold sinterable ceramic powder in an injection mold tool, placing an amount of polymer or polymer precursor molecules in the injection mold tool, applying an activating solvent for the powder in the injection mold tool, and applying sufficient heat and pressure to the powder, amount of polymer or polymer precursor molecules, and solvent to activate sintering of the powder.

Example 44 includes the method of example 43, wherein placing an amount of polymer or polymer precursor molecules in the injection mold tool includes placing an amount of thermoplastic polymer in the injection mold tool.

Example 45 includes the method any one of examples 43-44, wherein placing an amount of polymer or polymer precursor molecules in the injection mold tool includes placing an amount of resin in the injection mold tool, and wherein applying sufficient heat and pressure to the powder, amount of polymer or polymer precursor molecules, and solvent includes applying sufficient heat and pressure to polymerize the amount of resin.

Example 46 includes the method any one of examples 43-45, wherein a first temperature and pressure are applied to activate sintering of the powder, and a second temperature and pressure are applied to activate polymerization of the amount of resin.

Example 47 includes the method any one of examples 43-46, wherein placing an amount of polymer or polymer precursor molecules in the injection mold tool includes injecting an amount of partial cured polymer with a screw ram into the injection mold tool.

These and other examples and features of the present ceramic composite devices, materials, and related methods will be set forth in part in the above detailed description. This overview is intended to provide non-limiting examples of the present subject matter—it is not intended to provide an exclusive or exhaustive explanation.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of forming a sintered ceramic composite component, comprising:
placing an amount of powder, including a cold sinterable ceramic powder in a die;
placing an amount of polymer or polymer precursor molecules in the die;
applying an activating solvent for the powder in the die;
heating to a first temperature, and applying sufficient pressure to the powder, amount of polymer or polymer precursor molecules, and solvent to activate sintering of the powder; and
heating to a second temperature to anneal a polymer phase of the sintered ceramic composite component.

2. The method of claim 1, wherein the second temperature is equal to or greater than a glass transition temperature of an amorphous polymer phase.

3. The method of claim 1, wherein the second temperature is equal to or greater than a melting temperature of a semi-crystalline polymer phase.

4. The method of claim 1, further including holding the sintered ceramic composite component at pressure while cooling to room temperature.

5. The method of claim 1, wherein the polymer phase includes polyetherimide (PEI).

6. The method of claim 5, wherein the cold sinterable ceramic powder includes zinc oxide.

7. The method of claim 6, wherein applying sufficient pressure to the powder includes applying pressure less than or equal to 500 MPa.

8. The method of claim 7, wherein heating to the first temperature includes heating to a temperature no greater than 200° C. and above a boiling point of the activating solvent.

9. The method of claim 8, wherein heating to the second temperature includes heating to a temperature between about 220 and 260° C.

10. The method of claim 6, wherein placing the amount of polymer or polymer precursor molecules in the die includes placing an amount of polymer or polymer precursor molecules to yield a 20%-50% by volume fraction of polymer in the sintered ceramic composite component.

11. The method of claim 1, further including drying the amount of powder before sintering.

12. The method of claim 1, further including drying the sintered ceramic composite component after sintering.

13. The method of claim 1, wherein placing the amount of powder, including a cold sinterable ceramic powder in a die includes placing powder with an average diameter smaller than 30 μm.

14. The method of claim 1, wherein multiple components are stacked within a single die and sufficient heat and pressure are applied to the multiple components concurrently.
